(19) United States
(12) Patent Application Publication
(10) Pub. No.: US 2024/0383371 A1
(43) Pub. Date: Nov. 21, 2024

(54) POWER SOURCE RELIEF SERVER

(71) Applicant: NTT DOCOMO, INC., Tokyo (JP)

(72) Inventors: Yuta TOYAMA, Chiyoda-ku (JP); Masaki NAKAMURA, Chiyoda-ku (JP); Kazuhiko TAKENO, Chiyoda-ku (JP)

(73) Assignee: NTT DOCOMO, INC., Tokyo (JP)

(21) Appl. No.: 18/691,660

(22) PCT Filed: Sep. 8, 2022
(86) PCT No.: PCT/JP2022/033783

§ 371 Date: Mar. 13, 2024

(30) Foreign Application Priority Data
Oct. 4, 2021 (JP) 2021-163517

(51) Int. Cl. B60L 55/00; H02J 9/04

(52) U.S. Cl. CPC B60L 55/00; H02J 9/04; B60L 2260/52; B60L 2260/54; B60L 2260/58

(57) ABSTRACT

To provide a power source relief server capable of efficiently planning vehicles that enable power supply.

In a power source relief server 100, a power source relief implementation EV determination unit 104, each EV relief capability time calculation unit 104a, and a power source relief schedule determination unit 105 function as relief plan determination units, and a relief plan for a plurality of EVs 200 to supply power to a relief facility 300 is generated on the basis of the power consumption of the relief facility 300, the relief request time of the relief facility 300, and power source relief capability information (for example, power source relief allocable SOC) indicating relief capability power of a vehicle capable of power source relief. A power source relief schedule transmission unit 106 notifies an EV 200 or a driver or vehicle manager of the EV 200 of this relief plan.

### TECHNICAL FIELD

The present invention relates to a power source relief server for performing power source relief using a vehicle capable of providing power.

### BACKGROUND ART

In general, electric vehicles (EVs) are often regarded as mere automobiles, but in recent years, EVs have been regarded as distributed power sources for disaster countermeasures and thus are expected to be used as disaster countermeasures. The main method of use is to play a role of power backup by dispatching EVs to a facility and supplying power from storage batteries of the EVs when a power outage occurs at the facility due to occurrence of a disaster or the like.

For example, Patent Literature 1 discloses an emergency power distribution device including a vehicle determination module that determines a vehicle to request emergency power distribution and a guidance information transmission module that transmits guidance information to a hospital to the vehicle for which the request has been determined.

### CITATION LIST

### Patent Literature

[Patent Literature 1] Japanese Unexamined Patent Publication No. 2009-033808

### SUMMARY OF INVENTION

### Technical Problem

However, in the emergency power distribution device of Patent Literature 1, it is not possible to guide a vehicle to a facility at an appropriate timing. Therefore, there is a problem in that the vehicle is guided excessively and electric power cannot be supplied efficiently.

For example, power source relief is implemented by dispatching EVs when a power outage is expected to occur at a relief target facility. On the other hand, depending on relief target facilities, there may be facilities in which a plurality of EVs cannot supply power at the same time and only one EV can supply power at a time. In a case where a plurality of EVs are dispatched to the relief target facility at the same time without a plan in order to perform power source relief at such facilities, there is a possibility of some EVs being left unused without being utilized for power source relief and a possibility of EV drivers' work being wasted.

Consequently, in order to solve the above-described problems, an object of the present invention is to provide a power source relief server capable of efficiently planning vehicles that enable power supply.

### Solution to Problem

According to the present invention, there is provided a power source relief server including: a relief plan generation unit configured to generate a relief plan for supplying power to a relief facility using a vehicle capable of power source relief on the basis of power consumption of the relief facility, a relief request time of the relief facility, and power source relief capability information indicating relief capability power of the vehicle; and a notification unit configured to notify the vehicle or a vehicle manager of the relief plan.

### Advantageous Effects of Invention

According to the present invention, it is possible to formulate an efficient relief plan for power source relief.

### BRIEF DESCRIPTION OF DRAWINGS

FIG. 1 is a diagram schematically illustrating a power source relief system including a power source relief server 100 of the present disclosure.

FIG. 2 is a diagram illustrating a system configuration of the power source relief system including the power source relief server 100.

FIG. 3 is a block diagram illustrating a functional configuration of the power source relief server 100.

FIG. 4 is a flowchart (first half) illustrating operations of the power source relief server 100.

FIG. 5 is a flowchart (second half) illustrating operations of the power source relief server 100.

FIG. 6 is a block diagram illustrating a functional configuration of a power source relief server 100a which is a modification example of the power source relief server 100 of the present disclosure.

FIG. 7 is a flowchart (first half) illustrating operations of the power source relief server 100a.

FIG. 8 is a flowchart (second half) illustrating operations of the power source relief server 100a.

FIG. 9 is a diagram illustrating an example of a hardware configuration of the power source relief servers 100 and 100a according to an embodiment of the present disclosure.

### DESCRIPTION OF EMBODIMENTS

An embodiment of the present disclosure will be described with reference to the accompanying drawings. The same components are denoted, if possible, by the same reference numerals and signs, and thus description thereof will not be repeated.

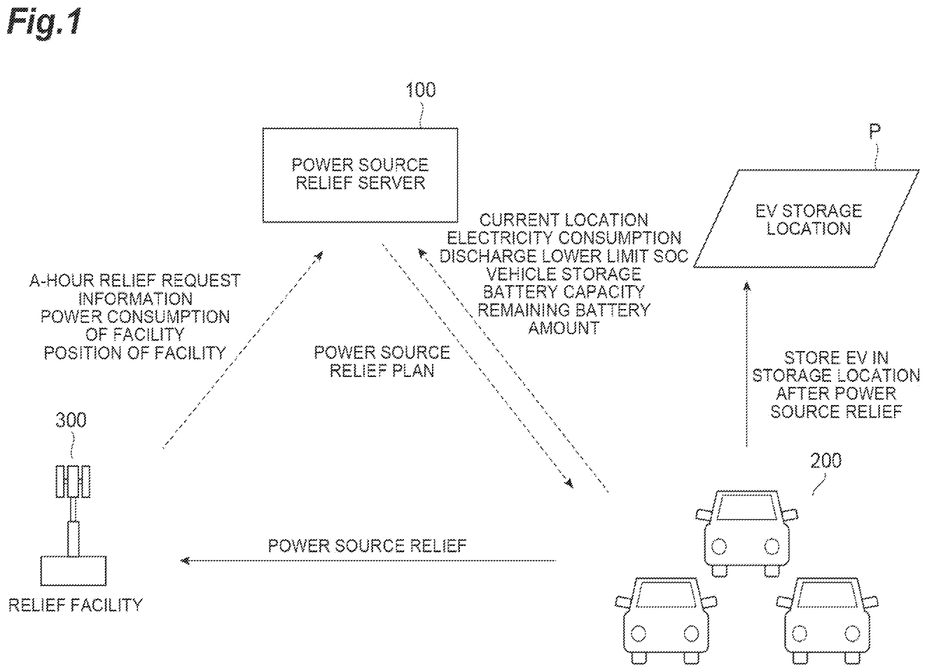

FIG. 1 is a diagram schematically illustrating a power source relief system including a power source relief server 100 of the present disclosure. As shown in the drawing, the power source relief server 100 receives A-hour relief request information from a relief facility 300. The A-hour relief request information indicates a request for supply of power for A hours. In the present disclosure, for example, in a case where there is an A-hour power outage at a certain facility, a relief time is notified of in order to have relief for that time.

When the A-hour relief request information is received, the power source relief server 100 acquires the power consumption and position information from the relief facility 300.

Further, when the A-hour relief request information is received, the power source relief server 100 acquires vehicle information including a current location, electricity consumption, a discharge lower limit SOC, a vehicle storage battery capacity, and a remaining battery amount from each EV 200. Based on this, the power source relief server 100 formulates a power source relief plan and notifies the driver or vehicle manager of each EV 100 of this plan. This power source relief plan includes a time at which the driver departs for the relief facility 300. Here, the term “electricity consumption” refers to fuel consumption of a so-called electric automobile, and indicates a distance traveled per unit of electric power (1 kWh). For example, it is indicated as 6 km/kwh or the like. The discharge lower limit SOC indicates a lower limit to which a storage battery can be discharged when supplying power. That is, this is a lower limit value set to prevent discharge below this value. It is mainly expressed as state of charge (SOC), indicating the charging state or charging rate.

An EV storage location P is a location to which each EV 200 heads after power source relief, and is a so-called parking lot. Each EV 200 needs to return to this EV storage location P after relief, and it is necessary to leave power for that purpose.

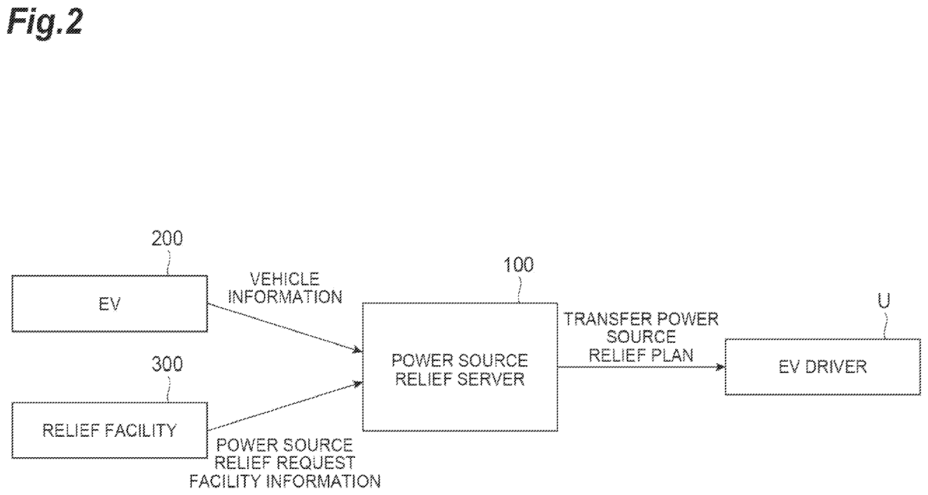

FIG. 2 is a diagram illustrating a system configuration of a power source relief system including the power source relief server 100. As shown in the drawing, the power source relief server 100 receives vehicle information, a power source relief request, and facility information from the EV 200 and the relief facility 300, and transfers a power source relief plan to an EV driver U (or a vehicle manager) on the basis of these.

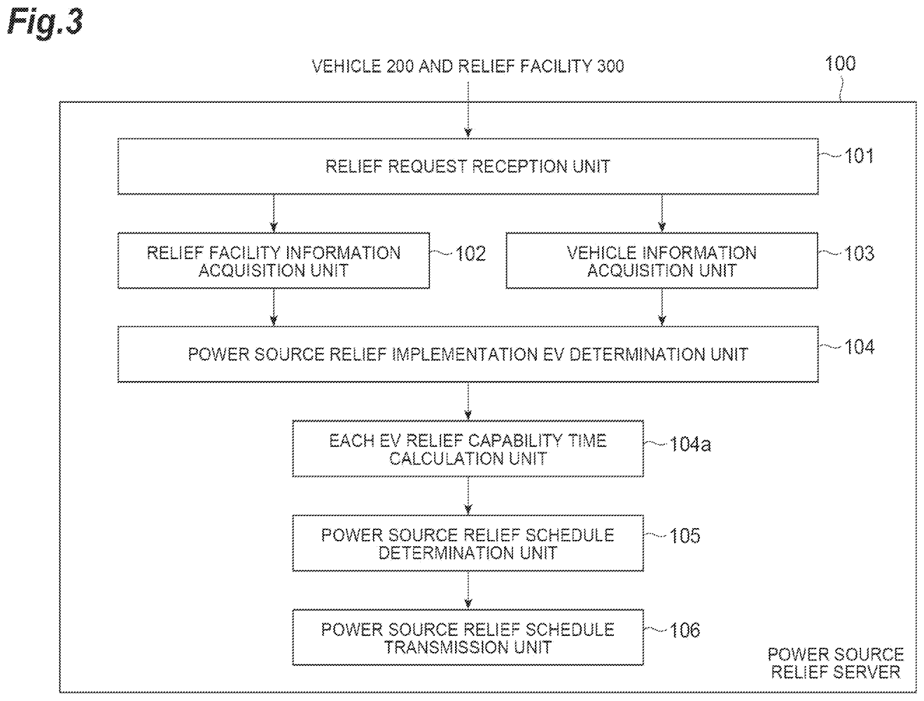

FIG. 3 is a block diagram illustrating a functional configuration of the power source relief server 100. As shown in the drawing, the power source relief server 100 is configured to include a relief request reception unit 101, a relief facility information acquisition unit 102, a vehicle information acquisition unit 103, a power source relief implementation EV determination unit 104, a power source relief schedule determination unit 105, and a power source relief schedule transmission unit 106.

The relief request reception unit 101 is a portion that receives relief request information from the relief facility 300. The relief request information is information including a request for power source relief and a relief request time. The relief request time is determined on the basis of a power outage time which will be taken for power to be restored after a power outage.

The relief facility information acquisition unit 102 is a portion that acquires facility information including the position of the relief facility 300 and its power consumption from the relief facility 300 or a management center (not shown) that manages the relief facility 300 when the relief request reception unit 101 receives the relief request information.

The vehicle information acquisition unit 103 is a portion that acquires vehicle information from each EV 200 or a vehicle management center (not shown) that manages each EV 200. As described above, the vehicle information includes a current location, electricity consumption, a discharge lower limit SOC, a vehicle storage battery capacity, and a remaining battery amount.

The power source relief implementation EV determination unit 104 is a portion that determines one or a plurality of EVs 200 to be subject to power source relief from a plurality of EVs 200 which are management targets on the basis of the relief facility information and the vehicle information.

Each EV relief capability time calculation unit 104a is a portion that calculates a time during which each EV 200 can supply power to the relief facility 300.

The power source relief schedule determination unit 105 is a portion that determines a power source relief schedule for the EV 200 indicating a power source relief plan so that the EV 200 can efficiently provide power to the relief facility 300. This power source relief schedule includes a notification of the departure time of the EV 200.

The power source relief schedule transmission unit 106 is a portion that transmits the power source relief schedule which is a power source relief plan to the EV 200 (its driver or vehicle manager) determined in the power source relief schedule determination unit 105.

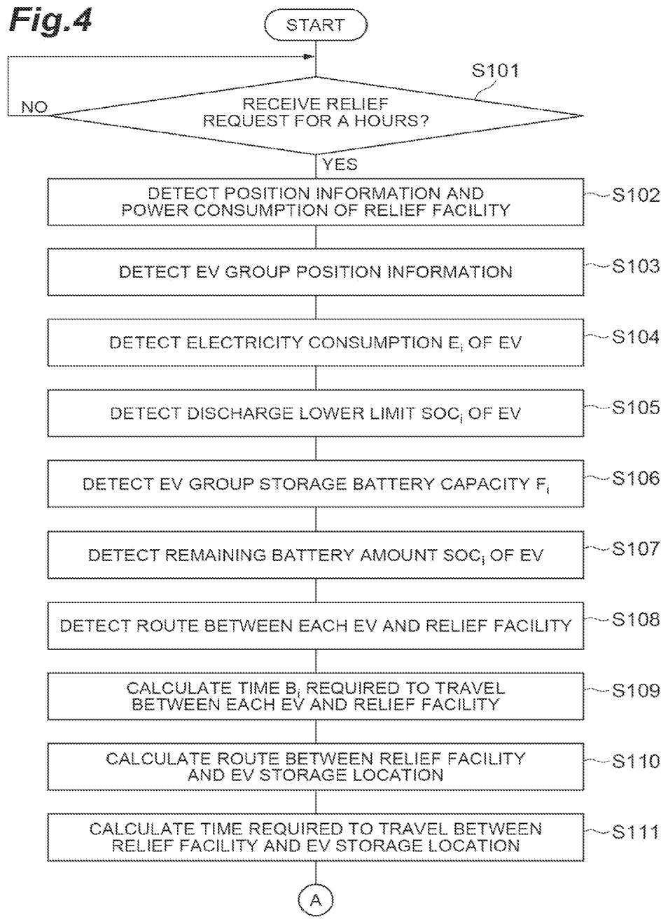

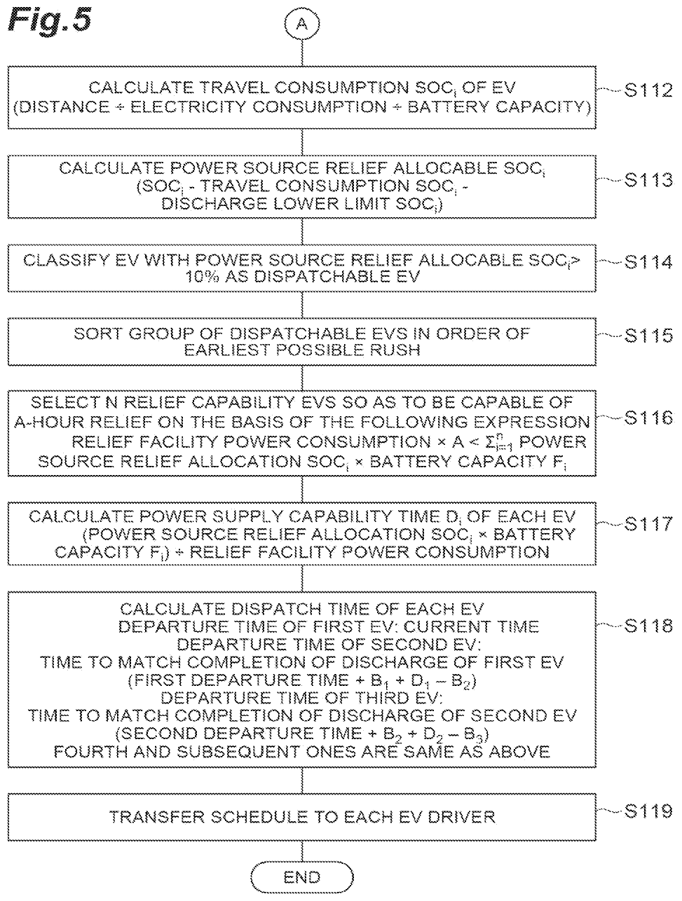

The operation of the power source relief server 100 configured in this way will be described. FIGS. 4 and 5 are flowcharts illustrating operations of the power source relief server 100. Meanwhile, in the following description, the subscript i indicates each EV 200 with i=1 to x (x is an arbitrary number). In addition, SOCi in the description indicates the charging rate or charging state ratio in the EV 200 (EV 200i). In the present disclosure, the SOC is used to express the remaining amount of a storage battery or the like, but there is no limitation thereto, and the remaining battery amount itself may be expressed.

The relief request reception unit 101 receives the A-hour relief request information (S101). Next, the relief facility information acquisition unit 102 acquires and detects facility information on the position information and power consumption of the relief facility 300 from the relief facility 300 (S102). In a case where the A-hour relief request information includes facility information including position information and power consumption, the relief facility information acquisition unit 102 may acquire the information from there.

In addition, the vehicle information acquisition unit 103 acquires and detects EV group position information (the position of each EV 200) (S103), acquires and detects the electricity consumption E of the EV 200 (S104), acquires and detects the discharge lower limit SOCi of the EV 200 (S105), acquires and detects the EV group storage battery capacity Fi (S106), and acquires and detects the remaining battery amount SOCi of the EV (S107). The vehicle information acquisition unit 103 may acquire each piece of information from each EV 200, or may acquire the information all at once.

In addition, the power source relief implementation EV determination unit 104 detects the travel route of each EV 200 to the relief facility 300 on the basis of the position information of each EV 200 acquired by the vehicle information acquisition unit 103 and the position information of the relief facility 300 acquired by the relief facility information acquisition unit 102 (S108). In addition, the power source relief implementation EV determination unit 104 calculates a travel time Bi required to travel between each EV 200 and the relief facility 300 on the basis of the travel route (S109). The power source relief implementation EV determination unit 104 calculates the travel route between the relief facility 300 and the EV storage location P (S110), and calculates the travel time (S111).

In FIG. 5, the power source relief implementation EV determination unit 104 calculates the travel consumption SOCi of the EV 200 (S112). The power source relief implementation EV determination unit 104 then calculates the power source relief allocable SOCi (S113). That is, power source relief allocable SOCi=remaining battery amount SOCi−travel consumption SOCi-discharge lower limit SOCi is calculated.

The power source relief implementation EV determination unit 104 classifies the EV 200 with power source relief allocable SOCi>10% as a dispatchable EV (S114). The power source relief implementation EV determination unit 104 then sorts a group of dispatchable EVs in the order of the earliest possible rush (S115). That is, it is sorted by the travel time Bi.

The power source relief implementation EV determination unit 104 selects n relief capability EVs 200 so as to be capable of A-hour relief (S116). That is, the power source relief implementation EV determination unit 104 calculates the following expression, and

$${\sum }_{i = l}^{n} power source relief allocation {SOC}_{i} \times battery capacity {F}_{i} \qquad [ Math . 1 ]$$

finds n for which this value is greater than relief facility power consumption×A.

Each EV relief capability time calculation unit 104a calculates the power supply capability time Di of each EV 200 (S117). That is, each EV relief capability time calculation unit 104a calculates power supply capability time Di=power source relief allocation SOCi×battery capacity Fi÷relief facility power consumption.

The power source relief schedule determination unit 105 calculates the departure time of each EV 200 (S118). That is, the power source relief schedule determination unit 105 sets the time of immediate departure, that is, the current time for a first EV 200, and sets departure times for the second and subsequent EVs 200 in consideration of the travel time of the EVs 200 so as to be in time for the completion of discharging (completion of power supply) of the EV 200 that departed before each EV.

More details are as follows. The first EV 200 is determined on the basis of the results sorted in step S115, and its departure time is set to the current time. For the second and subsequent EVs 200, the EV 200 that can rush at the earliest, that is, among the n EVs 200 determined in step S116 is determined as the first EV.

The second and subsequent ones are also determined in the order of sort. The departure times of the second and subsequent EVs are determined so that they arrive at a point in time when the EV 200 that departed previously has completed discharging (power source relief has been completed).

For example, the departure times are set as follows. Meanwhile, in consideration of the time required to work at the relief site, a hours may be subtracted from the time calculated below to depart earlier.
Departure time of the first EV 200: Current time when this process was performed
Departure time of the second EV 200: Time to match completion of discharge of the first EV 200→Departure time of the first EV+power supply capability time D1 of the first EV−travel time B2 of the second EV
Departure time of the third EV 200: Time to match completion of discharge of the second EV 200→Departure time of the second EV+power supply capability time D2 of the second EV−travel time B3 of the third EV

For the fourth and subsequent ones, the same calculations as for the second and third ones are performed.

The power source relief schedule transmission unit 106 transfers the power source relief schedule (dispatch time) to the drivers (or vehicle managers) of the n EVs 200 selected in step S116 (S119).

In this way, the power source relief server 100 can formulate a relief plan of the EV 200 on the basis of the position of the relief facility 300 and the relief time, and can perform efficient relief.

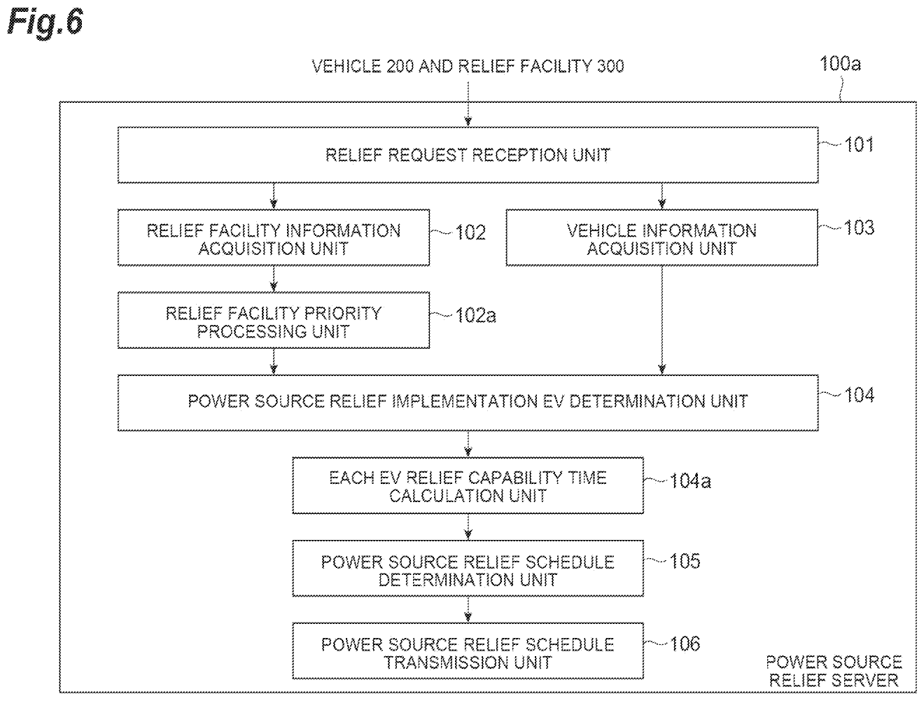

Next, a modification example in the present disclosure will be described. FIG. 6 is a block diagram illustrating a functional configuration of a power source relief server 100a which is a modification example of the power source relief server 100 of the present disclosure. As shown in the drawing, the power source relief server 100a is configured to include a relief facility priority processing unit 102a in addition to the relief request reception unit 101, the relief facility information acquisition unit 102, the vehicle information acquisition unit 103, the power source relief implementation EV determination unit 104, the power source relief schedule determination unit 105, and the power source relief schedule transmission unit 106. The power source relief server 100a differs from the power source relief server 100 in that the relief facility priority processing unit 102a is added. Description will be given below with a focus on this difference.

The relief facility priority processing unit 102a is a portion that stores the priority of each relief facility 300 and formulates relief for the relief facility 300 in accordance with the priority.

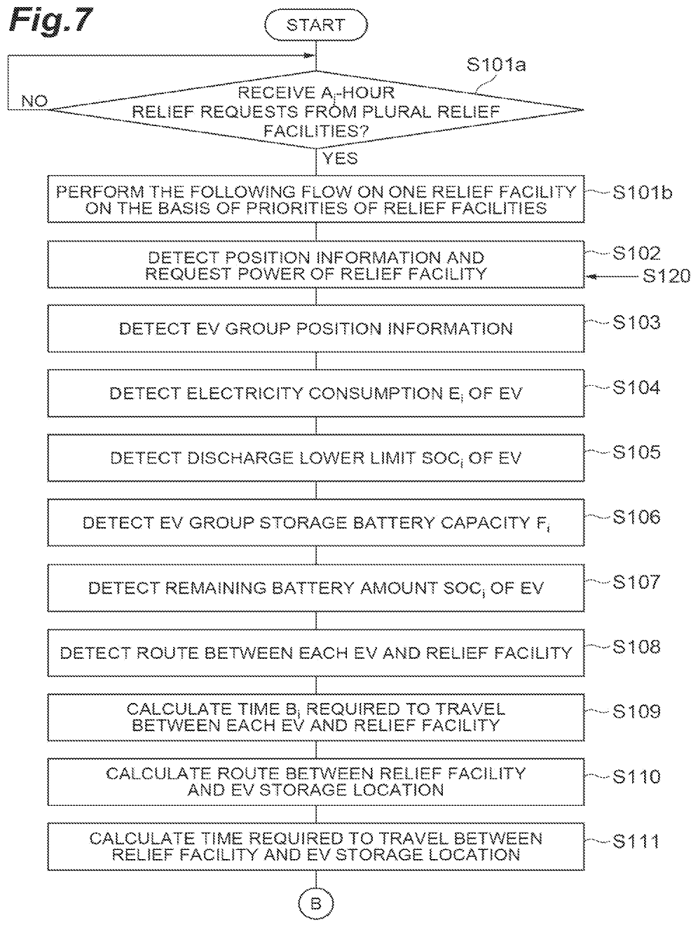

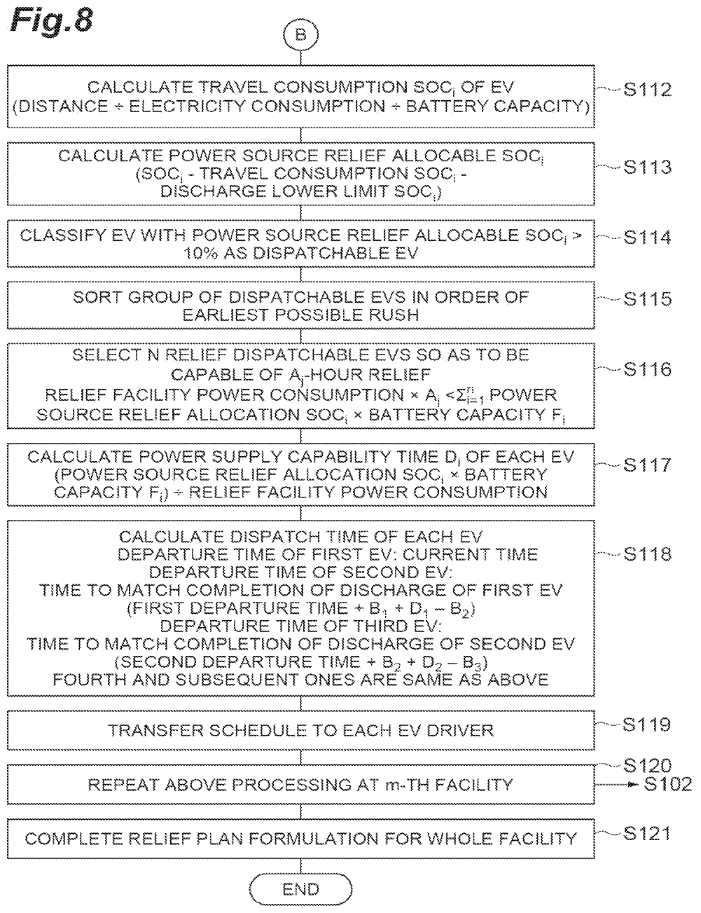

Next, the operation of the power source relief server 100a in this modification example will be described. FIG. 7 and FIG. 8 are flowcharts illustrating operations of the power source relief server 100a. As shown in the drawing, the relief request reception unit 101 receives Aj-hour relief requests from a plurality of relief facilities 300 (S101a). Aj indicates the relief request time of the relief facility 300j. In addition, j indicates each of the relief facilities 300. The relief facility priority processing unit 102a selects one relief facility 300 on the basis of the stored priorities of the relief facilities 300 (S101b).

Thereafter, the power source relief implementation EV determination unit 104 determines an EV 200 that causes the relief facility 300j selected by the relief facility priority processing unit 102a to perform relief (S102 to S116). Steps S102 to S106 are as described above, and thus the description thereof will be omitted. Each EV relief capability time calculation unit 104a calculates the relief capability time of each EV 200 (S117), and based on that, the power source relief schedule determination unit 105 determines a power source relief schedule (S118). The power source relief schedule transmission unit 106 transmits the power source relief schedule to the driver of each EV 200 (s119).

When the processing for one relief facility 300 is completed, the power source relief implementation EV determination unit 104 sets m=m+1 and performs the relief processing on the next (m-th) relief facility 300 (S120). In the present modification example, the process returns to step S102 and these processes are repeatedly performed. The relief facility priority processing unit 102a confirms the completion of the processing for all relief facilities 300 that have requested relief, and then completes the relief plan formulation (S121).

The operational effects of the power source relief servers 100 and 100a configured in this way will be described. Meanwhile, the following description will relates to the power source relief server 100, but unless otherwise stated, the power source relief server 100a is assumed to have the same operational effects.

In the power source relief server 100, the power source relief implementation EV determination unit 104, each EV relief capability time calculation unit 104a, and the power source relief schedule determination unit 105 function as relief plan generation units, and a power source relief plan for a plurality of EVs 200 to supply power to the relief facility 300 is generated on the basis of the power consumption of the relief facility 300, the relief request time of the relief facility 300, and the power source relief capability information (for example, power source relief allocable SOC) indicating the relief capability power of a vehicle capable of power source relief. The power source relief schedule transmission unit 106 notifies the EV 200 or the driver or vehicle manager of the EV 200 of this power source relief plan. Specifically, the power source relief schedule determination unit 105 determines the departure time of each of the plurality of EVs 200 as a relief plan.

In addition, when a power source relief plan is generated, the power source relief implementation EV determination unit 104 determines a plurality of EVs 200 that can be dispatched on the basis of the power consumption, the relief request time, and the power source relief capability information (for example, power source relief allocable SOCi) in management target vehicles (EVs 200). A power source relief plan is generated for the plurality of EVs 200 that can be dispatched.

This makes it possible to efficiently dispatch the EV 200 to the relief facility 300 to supply power. Therefore, there is no need to dispatch a large number of EVs 200.

In addition, the power source relief server 100 further includes the vehicle information acquisition unit 103 that acquires vehicle information including remaining battery amount information (for example, remaining battery amount SOCi) of a storage battery for power supply of each management target vehicle (EV 200) in management target vehicles (EVs 200) including a plurality of EVs 200 and the position of each management target vehicle.

The power source relief implementation EV determination unit 104 determines one or a plurality of EVs 200 from among the management target vehicles (EVs 200) on the basis of the vehicle information.

In the present disclosure, the management target vehicle is an electric automobile that supplies power to the relief facility 300 using a storage battery and is capable of self-propelling using the storage battery.

The power source relief implementation EV determination unit 104 calculates travel power consumption information (for example, travel consumption SOCi) of each management target vehicle (EV 200) on the basis of the position of each management target vehicle (EV 200) and the position of the relief facility 300, adjusts the power source relief capability information (for example, remaining battery amount SOCi) with the travel power consumption information, and determines a plurality of EVs 200 that can be dispatched on the basis of the adjusted power source relief capability information (power source relief allocable SOCi).

With such a configuration, even if the electric automobile consumes its own storage battery through self-propulsion, the EV 200 that can be dispatched to the relief facility 300 can be determined on the basis of the power source relief allocable SOCi that takes this into consideration.

In addition, the power source relief implementation EV determination unit 104 obtains the travel distance from the relief facility 300 to the EV storage location P on the basis of the storage location of the EV 200 which is a management target vehicle, and calculates the travel power consumption information (for example, travel consumption SOCi) inclusive of the travel distance.

It is possible to obtain the power source relief allocable SOCi in consideration of the storage location of the electric automobile for return after power source relief, and to determine an appropriate EV 200.

In addition, the power source relief implementation EV determination unit 104 obtains the power source relief capability information (for example, power source relief allocation SOCi) on the basis of discharge lower limit information (for example, discharge lower limit SOCi) in the storage battery for power supply of the EV 200 which is a management target vehicle.

Thereby, since an EV 200 that falls below the discharge lower limit is not determined as an EV 200 to be dispatched, it is possible to determine an appropriate EV 200.

In addition, the power source relief implementation EV determination unit 104 determines a plurality of EVs 200 that can be dispatched on the basis of the travel time obtained on the basis of the position of each of the plurality of EVs 200 and the position of the relief facility 300.

That is, the power source relief implementation EV determination unit 104 can determine an EV 200 that can rush to the relief facility 300 at the earliest. For example, by sorting the EVs 200 on the basis of the travel time, it is possible to line up the EVs 200 in the order of the shortest travel time, and to determine which EV 200 to dispatch on the basis of this.

In addition, the power source relief implementation EV determination unit 104 calculates a power supply capability time Di for the relief facility 300 in the plurality of EVs 200, and generates a power source relief plan of each of the plurality of EVs 200 on the basis of the power supply capability time Di.

This makes it possible to dispatch the next EV 200 to the relief facility 300 at the end of power supply of the EV 200, and to formulate an efficient power supply plan.

In addition, in the power source relief server 100a, in a case where there are a plurality of relief facilities 300, priorities are allocated to the relief facility 300, and the power source relief implementation EV determination unit 104 or the like generates a power source relief plan in accordance with the priority of each of the plurality of relief facilities 300.

This makes it possible to perform appropriate relief processing even if relief requests are received from the relief facilities 300 at the same time.

In the above disclosure, the EV 200 is determined by considering the position of the relief facility and the position of the EV 200, but in a case where these positions are known or a case where the facility and each EV 200 are close enough for their positions not to need to be considered, information relating to these positions and information relating to travel may not be used in generating a power source relief plan.

The block diagram used for the description of the above embodiments shows blocks of functions. Those functional blocks (component parts) are implemented by any combination of at least one of hardware and software. Further, a means of implementing each functional block is not particularly limited. Specifically, each functional block may be implemented by one physically or logically combined device or may be implemented by two or more physically or logically separated devices that are directly or indirectly connected (e.g., by using wired or wireless connection etc.). The functional blocks may be implemented by combining software with the above-described one device or the above-described plurality of devices.

The functions include determining, deciding, judging, calculating, computing, processing, deriving, investigating, looking up/searching/inquiring, ascertaining, receiving, transmitting, outputting, accessing, resolving, selecting, choosing, establishing, comparing, assuming, expecting, considering, broadcasting, notifying, communicating, forwarding, configuring, reconfiguring, allocating/mapping, assigning and the like, though not limited thereto. For example, the functional block (component part) that implements the function of transmitting is referred to as a transmitting unit or a transmitter. In any case, a means of implementation is not particularly limited as described above.

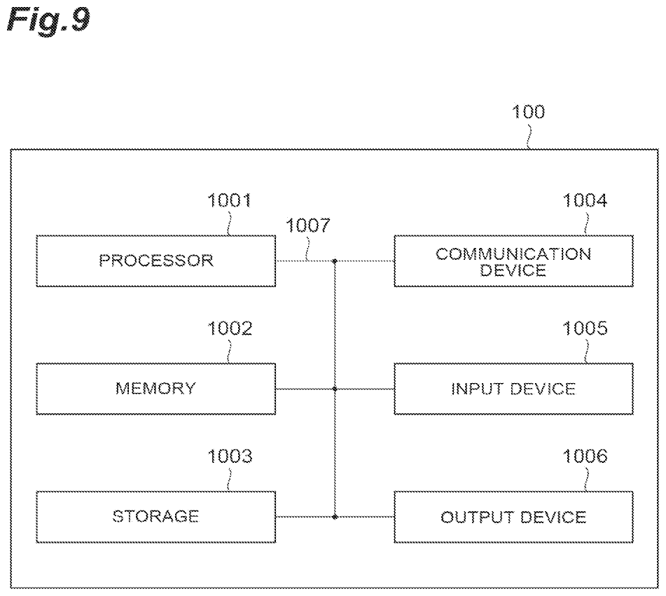

For example, the power source relief server 100, 100a, and the like according to one embodiment of the present disclosure may function as a computer that performs processing of a power source relief method or a conversation information generation method according to the present disclosure. FIG. 9 is a view showing an example of the hardware configuration of the power source relief server 100 and 100a according to one embodiment of the present disclosure. The power source relief server 100 and 100a described above may be physically configured as a computer device that includes a processor 1001, a memory 1002, a storage 1003, a communication device 1004, an input device 1005, an output device 1006, a bus 1007 and the like.

In the following description, the term “device” may be replaced with a circuit, a device, a unit, or the like. The hardware configuration of the power source relief server 100 and 100a may be configured to include one or a plurality of the devices shown in the drawings or may be configured without including some of those devices.

The functions of the power source relief server 100 and 100a may be implemented by loading predetermined software (programs) on hardware such as the processor 1001 and the memory 1002, so that the processor 1001 performs computations to control communications by the communication device 1004 and control at least one of reading and writing of data in the memory 1002 and the storage 1003.

The processor 1001 may, for example, operate an operating system to control the entire computer. The processor 1001 may be configured to include a CPU (Central Processing Unit) including an interface with a peripheral device, a control device, an arithmetic device, a register and the like. For example, the power source relief implementation EV determination unit 104, the each EV relief capability time calculation unit 104a, the power source relief schedule determination unit 105 and the like described above may be implemented by the processor 1001.

Further, the processor 1001 loads a program (program code), a software module and data from at least one of the storage 1003 and the communication device 1004 into the memory 1002 and performs various processing according to them. As the program, a program that causes a computer to execute at least some of the operations described in the above embodiments is used. For example, the power source relief implementation EV determination unit 104 may be implemented by a control program that is stored in the memory 1002 and operates on the processor 1001, and the other functional blocks may be implemented in the same way. Although the above-described processing is executed by one processor 1001 in the above description, the processing may be executed simultaneously or sequentially by two or more processors 1001. The processor 1001 may be implemented in one or more chips. Note that the program may be transmitted from a network through a telecommunications line.

The memory 1002 is a computer-readable recording medium, and it may be composed of at least one of ROM (Read Only Memory), EPROM (ErasableProgrammable ROM), EEPROM (Electrically ErasableProgrammable ROM), RAM (Random Access Memory) and the like, for example. The memory 1002 may be also called a register, a cache, a main memory (main storage device) or the like. The memory 1002 can store a program (program code), a software module and the like that can be executed for implementing a power source relief method according to one embodiment of the present disclosure.

The storage 1003 is a computer-readable recording medium, and it may be composed of at least one of an optical disk such as a CD-ROM (Compact Disk ROM), a hard disk drive, a flexible disk, a magneto-optical disk (e.g., a compact disk, a digital versatile disk, and a Blu-ray (registered trademark) disk), a smart card, a flash memory (e.g., a card, a stick, and a key drive), a floppy (registered trademark) disk, a magnetic strip and the like, for example. The storage 1003 may be called an auxiliary storage device. The above-described storage medium may be a database, a server, or another appropriate medium including at least one of the memory 1002 and/or the storage 1003, for example.

The communication device 1004 is hardware (a transmitting and receiving device) for performing communication between computers via at least one of a wired network and a wireless network, and it may also be referred to as a network device, a network controller, a network card, a communication module, or the like. The communication device 1004 may include a high-frequency switch, a duplexer, a filter, a frequency synthesizer or the like in order to implement at least one of FDD (Frequency Division Duplex) and TDD (Time Division Duplex), for example. For example, the above-described relief request reception unit 101 or the like may be implemented by the communication device 1004. This relief request reception unit 101 may be implemented in such a way that a transmitting unit and a receiving unit are physically or logically separated.

The input device 1005 is an input device (e.g., a keyboard, a mouse, a microphone, a switch, a button, a sensor, etc.) that receives an input from the outside. The output device 1006 is an output device (e.g., a display, a speaker, an LED lamp, etc.) that makes output to the outside. Note that the input device 1005 and the output device 1006 may be integrated (e.g., a touch panel).

In addition, the devices such as the processor 1001 and the memory 1002 are connected by the bus 1007 for communicating information. The bus 1007 may be a single bus or may be composed of different buses between different devices.

Further, the power source relief server 100 and 100a may include hardware such as a microprocessor, a DSP (Digital Signal Processor), an ASIC (Application Specific Integrated Circuit), a PLD (Programmable Logic Device), and an FPGA (Field Programmable Gate Array), and some or all of the functional blocks may be implemented by the above-described hardware components. For example, the processor 1001 may be implemented with at least one of these hardware components.

Notification of information may be made by another method, not limited to the aspects/embodiments described in the present disclosure. For example, notification of information may be made by physical layer signaling (e.g., DCI (Downlink Control Information), UCI (Uplink Control Information)), upper layer signaling (e.g., RRC (Radio Resource Control) signaling, MAC (Medium Access Control) signaling, annunciation information (MIB (Master Information Block), SIB (System Information Block))), another signal, or a combination of them. Further, RRC signaling may be called an RRC message, and it may be an RRC Connection Setup message, an RRC Connection Reconfiguration message or the like, for example.

The procedure, the sequence, the flowchart and the like in each of the aspects/embodiments described in the present disclosure may be in a different order unless inconsistency arises. For example, for the method described in the present disclosure, elements of various steps are described in an exemplified order, and it is not limited to the specific order described above.

Input/output information or the like may be stored in a specific location (e.g., memory) or managed in a management table. Further, input/output information or the like can be overwritten or updated, or additional data can be written. Output information or the like may be deleted. Input information or the like may be transmitted to another device.

The determination may be made by a value represented by one bit (0 or 1), by a truth-value (Boolean: true or false), or by numerical comparison (e.g., comparison with a specified value).

Each of the aspects/embodiments described in the present disclosure may be used alone, may be used in combination, or may be used by being switched according to the execution. Further, a notification of specified information (e.g., a notification of “being X”) is not limited to be made explicitly, and it may be made implicitly (e.g., a notification of the specified information is not made).

Although the present disclosure is described in detail above, it is apparent to those skilled in the art that the present disclosure is not restricted to the embodiments described in this disclosure. The present disclosure can be implemented as a modified and changed form without deviating from the spirit and scope of the present disclosure defined by the appended claims. Accordingly, the description of the present disclosure is given merely by way of illustration and does not have any restrictive meaning to the present disclosure.

Software may be called any of software, firmware, middle ware, microcode, hardware description language or another name, and it should be interpreted widely so as to mean an instruction, an instruction set, a code, a code segment, a program code, a program, a sub-program, a software module, an application, a software application, a software package, a routine, a sub-routine, an object, an executable file, a thread of execution, a procedure, a function and the like.

Further, software, instructions and the like may be transmitted and received via a transmission medium. For example, when software is transmitted from a website, a server or another remote source using at least one of wired technology (a coaxial cable, an optical fiber cable, a twisted pair and a digital subscriber line (DSL) etc.) and wireless technology (infrared rays, microwave etc.), at least one of those wired technology and wireless technology are included in the definition of the transmission medium.

The information, signals and the like described in the present disclosure may be represented by any of various different technologies. For example, data, an instruction, a command, information, a signal, a bit, a symbol, a chip and the like that can be referred to in the above description may be represented by a voltage, a current, an electromagnetic wave, a magnetic field or a magnetic particle, an optical field or a photon, or an arbitrary combination of them.

Note that the term described in the present disclosure and the term needed to understand the present disclosure may be replaced by a term having the same or similar meaning. For example, at least one of a channel and a symbol may be a signal (signaling). Further, a signal may be a message. Furthermore, a component carrier (CC) may be called a cell, a frequency carrier, or the like.

Further, information, parameters and the like described in the present disclosure may be represented by an absolute value, a relative value to a specified value, or corresponding different information. For example, radio resources may be indicated by an index.

The names used for the above-described parameters are not definitive in any way. Further, mathematical expressions and the like using those parameters are different from those explicitly disclosed in the present disclosure in some cases. Because various channels (e.g., PUCCH, PDCCH etc.) and information elements (e.g., TPC etc.) can be identified by every appropriate names, various names assigned to such various channels and information elements are not definitive in any way.

In the present disclosure, the terms such as “Mobile Station (MS)” “user terminal”, “User Equipment (UE)” and “terminal” can be used to be compatible with each other.

The mobile station can be also called, by those skilled in the art, a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client or several other appropriate terms.

Note that the term “determining” and “determining” used in the present disclosure includes a variety of operations. For example, “determining” and “determining” can include regarding the act of judging, calculating, computing, processing, deriving, investigating, looking up/searching/inquiring (e.g., looking up in a table, a database or another data structure), ascertaining or the like as being “determined” and “determined”. Further, “determining” and “determining” can include regarding the act of receiving (e.g., receiving information), transmitting (e.g., transmitting information), inputting, outputting, accessing (e.g., accessing data in a memory) or the like as being “determined” and “determined”. Further, “determining” and “determining” can include regarding the act of resolving, selecting, choosing, establishing, comparing or the like as being “determined” and “determined”. In other words, “determining” and “determining” can include regarding a certain operation as being “determined” and “determined”. Further, “determining (determining)” may be replaced with “assuming”, “expecting”, “considering” and the like.

The term “connected”, “coupled” or every transformation of this term means every direct or indirect connection or coupling between two or more elements, and it includes the case where there are one or more intermediate elements between two elements that are “connected” or “coupled” to each other. The coupling or connection between elements may be physical, logical, or a combination of them. For example, “connect” may be replaced with “access”. When used in the present disclosure, it is considered that two elements are “connected” or “coupled” to each other by using at least one of one or more electric wires, cables, and printed electric connections and, as several non-definitive and non-comprehensive examples, by using electromagnetic energy such as electromagnetic energy having a wavelength of a radio frequency region, a microwave region and an optical (both visible and invisible) region.

The description “on the basis of” used in the present disclosure does not mean “only on the basis of” unless otherwise noted. In other words, the description “on the basis of” means both of “only on the basis of” and “at least on the basis of”.

When the terms such as “first” and “second” are used in the present disclosure, any reference to the element does not limit the amount or order of the elements in general. Those terms can be used in the present disclosure as a convenient way to distinguish between two or more elements. Thus, reference to the first and second elements does not mean that only two elements can be adopted or the first element needs to precede the second element in a certain form.

As long as “include”, “including” and transformation of them are used in the present disclosure, those terms are intended to be comprehensive like the term “comprising”. Further, the term “or” used in the present disclosure is intended not to be exclusive OR.

In the present disclosure, when articles, such as “a”, “an”, and “the” in English, for example, are added by translation, the present disclosure may include that nouns following such articles are plural.

In the present disclosure, the term “A and B are different” may mean that “A and B are different from each other”. Note that this term may mean that “A and B are different from C”. The terms such as “separated” and “coupled” may be also interpreted in the same manner.

### REFERENCE SIGNS LIST

101 Relief request reception unit
102 Relief facility information acquisition unit
103 Vehicle information acquisition unit
104 Power source relief implementation EV determination unit
105 Power source relief schedule determination unit
106 Power source relief schedule transmission unit
104a EV relief capability time calculation unit

1. A power source relief server comprising:
a relief plan generation unit configured to generate a relief plan for supplying power to a relief facility using a vehicle capable of power source relief on the basis of power consumption of the relief facility, a relief request time of the relief facility, and power source relief capability information indicating relief capability power of the vehicle; and
a notification unit configured to notify the vehicle or a vehicle manager of the relief plan.

2. The power source relief server according to claim 1, wherein the relief plan generation unit determines a departure time of each of the vehicles as a relief plan.

3. The power source relief server according to claim 1, wherein the relief plan generation unit determines the vehicle which is able to be dispatched on the basis of the power consumption, the relief request time, and the power source relief capability information for management target vehicles, and generates a relief plan for the vehicle.

4. The power source relief server according to claim 1, further comprising a vehicle information acquisition unit configured to acquire vehicle information including remaining battery amount information of a storage battery for power supply of each management target vehicle in management target vehicles including the vehicle and a position of each management target vehicle,
wherein the relief plan generation unit determines the vehicle from among the management target vehicles on the basis of a position of the relief facility and the vehicle information.

5. The power source relief server according to claim 4, wherein the management target vehicle is an electric automobile that supplies power to the relief facility using a storage battery and is capable of self-propelling using the storage battery, and
the relief plan generation unit calculates travel power consumption information of each of the management target vehicles on the basis of a position of each of the management target vehicles and a position of the relief facility, adjusts the power source relief capability information with the travel power consumption information, and determines the vehicle which is able to be dispatched on the basis of the adjusted power source relief capability information.

6. The power source relief server according to claim 5, wherein the relief plan generation unit obtains a travel distance from the relief facility to the storage location on the basis of a storage location of the management target vehicle, and calculates the travel power consumption information inclusive of the travel distance.

7. The power source relief server according to claim 5, wherein the relief plan generation unit obtains the power source relief capability information on the basis of discharge lower limit information in the storage battery for power supply of the management target vehicle.

8. The power source relief server according to claim 5, wherein the relief plan generation unit determines the vehicle which is able to be dispatched on the basis of a travel time obtained on the basis of the position of each of the vehicles and the position of the relief facility.

9. The power source relief server according to according to claim 1, wherein the relief plan generation unit calculates a power supply capability time for the relief facility in the vehicle, and generates a relief plan of each of the vehicles on the basis of the power supply capability time.

10. The power source relief server according to claim 1, wherein, in a case where there are a plurality of relief facilities, priorities are allocated to the relief facilities, and
the relief plan generation unit generates a relief plan in accordance with the priority of each of the plurality of relief facilities.

11. The power source relief server according to claim 2, wherein the relief plan generation unit determines the vehicle which is able to be dispatched on the basis of the power consumption, the relief request time, and the power source relief capability information for management target vehicles, and generates a relief plan for the vehicle.

12. The power source relief server according to claim 2, further comprising a vehicle information acquisition unit configured to acquire vehicle information including remaining battery amount information of a storage battery for power supply of each management target vehicle in management target vehicles including the vehicle and a position of each management target vehicle,
wherein the relief plan generation unit determines the vehicle from among the management target vehicles on the basis of a position of the relief facility and the vehicle information.

13. The power source relief server according to claim 3, further comprising a vehicle information acquisition unit configured to acquire vehicle information including remaining battery amount information of a storage battery for power supply of each management target vehicle in management target vehicles including the vehicle and a position of each management target vehicle,
wherein the relief plan generation unit determines the vehicle from among the management target vehicles on the basis of a position of the relief facility and the vehicle information.

14. The power source relief server according to claim 6, wherein the relief plan generation unit obtains the power source relief capability information on the basis of discharge lower limit information in the storage battery for power supply of the management target vehicle.

15. The power source relief server according to claim 6, wherein the relief plan generation unit determines the vehicle which is able to be dispatched on the basis of a travel time obtained on the basis of the position of each of the vehicles and the position of the relief facility.

16. The power source relief server according to claim 7, wherein the relief plan generation unit determines the vehicle which is able to be dispatched on the basis of a travel time obtained on the basis of the position of each of the vehicles and the position of the relief facility.

17. The power source relief server according to claim 2, wherein the relief plan generation unit calculates a power supply capability time for the relief facility in the vehicle, and generates a relief plan of each of the vehicles on the basis of the power supply capability time.

18. The power source relief server according to claim 3, wherein the relief plan generation unit calculates a power supply capability time for the relief facility in the vehicle, and generates a relief plan of each of the vehicles on the basis of the power supply capability time.

19. The power source relief server according to 4, wherein the relief plan generation unit calculates a power supply capability time for the relief facility in the vehicle, and generates a relief plan of each of the vehicles on the basis of the power supply capability time.

20. The power source relief server according to claim 5, wherein the relief plan generation unit calculates a power supply capability time for the relief facility in the vehicle, and generates a relief plan of each of the vehicles on the basis of the power supply capability time.
